(19) United States
(12) Patent Application Publication
(10) Pub. No.: US 2017/0162952 A1
(43) Pub. Date: Jun. 8, 2017

(54) MULTI-LOOP ANTENNA

(71) Applicant: Checkpoint Systems, Inc., Thorofare, NJ (US)

(72) Inventor: Kefeng Zeng, West Deptford, NJ (US)

(21) Appl. No.: 14/958,543

(22) Filed: Dec. 3, 2015

(51) Int. Cl. H01Q 21/30

(52) U.S. Cl. CPC H01Q 21/30

(57) ABSTRACT

In one embodiment, the invention can be a radio frequency identification (RFID) tag including a substrate; a dipole antenna on the substrate; a first loop antenna on the substrate; a first integrated circuit operably coupled to the first loop antenna; a second loop antenna on the substrate; and a second integrated circuit operably coupled to the second loop antenna; wherein the first loop antenna is operatively coupled to the dipole antenna and the first integrated circuit to operate at a first resonant frequency, and the second loop antenna is operatively coupled to the dipole antenna and the second integrated circuit to operate at a second resonant frequency, the first resonant frequency being different from the second resonant frequency.

### BACKGROUND

A tag antenna is generally tuned to receive waves of a particular frequency. Such is the case, for example, with antennas used for Ultra High Frequency (UHF) radio frequency identification (RFID) tags. When the antenna is placed on certain objects or product packaging, however, the antenna can be detuned, making it difficult for the tag to receive enough energy to reflect back a signal.

To address detuning, some tags are designed to account for the detuning effects of the particular type of merchandise being tagged. For example, a tag antenna for a water-based product can be designed to be in tune when the tag is close to water. The problem with this approach, however, is that the tag can become exclusive for a specific type of merchandise and not work well with other types of merchandise.

Further, the particular type of merchandise being tagged may have different areas causing different detuning effects. For example, the exterior of a meat package will often include a transparent cover, with certain portions of the transparent cover overlying the meat and certain portions of the transparent cover overlying an air gap. The RFID tag may be applied over the meat, over the air gap, or in between. The detuning effect can vary dramatically depending on where the tag is attached. For these reasons, it is desirable to have a tag that can more fully address the issues associated with detuning.

### BRIEF SUMMARY

The present disclosure is directed to a tag and method. In one aspect, the tag can be an RFID tag that includes a substrate; a dipole antenna on the substrate; a first loop antenna on the substrate; a first integrated circuit operably coupled to the first loop antenna; a second loop antenna on the substrate; and a second integrated circuit operably coupled to the second loop antenna; wherein the first loop antenna is operatively coupled to the dipole antenna and the first integrated circuit to operate at a first resonant frequency, and the second loop antenna is operatively coupled to the dipole antenna and the second integrated circuit to operate at a second resonant frequency, the first resonant frequency being different from the second resonant frequency.

In another aspect, a method includes providing a substrate; securing a dipole antenna to the substrate; securing a first loop antenna to the substrate; operably coupling a first integrated circuit to the first loop antenna; securing a second loop antenna to the substrate; and operably coupling a second integrated circuit to the second loop antenna; wherein the first loop antenna is operatively coupled to the dipole antenna and the first integrated circuit to operate at a first resonant frequency, and the second loop antenna is operatively coupled to the dipole antenna and the second integrated circuit to operate at a second resonant frequency, the first resonant frequency being different from the second resonant frequency.

In yet another aspect, a tag includes a substrate; a dipole antenna on the substrate; a first loop antenna on the substrate; and a second loop antenna on the substrate; wherein the first loop antenna is operatively coupled to the dipole antenna and the first integrated circuit to operate at a first resonant frequency, and the second loop antenna is operatively coupled to the dipole antenna and the second integrated circuit to operate at a second resonant frequency, the first resonant frequency being different from the second resonant frequency.

Further areas of applicability of the present tag and method will become apparent from the detailed description provided hereinafter. It should be understood that the detailed description and specific examples, while indicating certain embodiments, are intended for purposes of illustration only and are not intended to limit the scope of the tag and method.

### BRIEF DESCRIPTION OF THE DRAWINGS

The invention of the present disclosure will become more fully understood from the detailed description and the accompanying drawings, wherein:

FIG. 1 is a system according to one embodiment of the present invention.

FIG. 2 is a tag according to another embodiment of the present invention.

FIG. 3 is a graph of the simulated frequency response of the tag of FIG. 2.

FIG. 4 is a tagged meat package according to one embodiment of the present invention.

FIG. 5 is a flowchart of a method of manufacturing an RFID tag according to one embodiment of the present invention.

### DETAILED DESCRIPTION

The following description of the preferred embodiment(s) is merely exemplary in nature and is in no way intended to limit the invention. The description of illustrative embodiments is intended to be read in connection with the accompanying drawings, which are to be considered part of the entire written description. In the description of the exemplary embodiments disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “left,” “right,” “top,” “bottom,” “front” and “rear” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” “secured” and similar refer to a relationship wherein structures are secured or attached to one another either directly or indirectly through intervening structures, as well as both movable or rigid attachments or relationships, unless expressly described otherwise. The discussion herein describes and illustrates some possible non-limiting combinations of features that may exist alone or in other combinations of features.

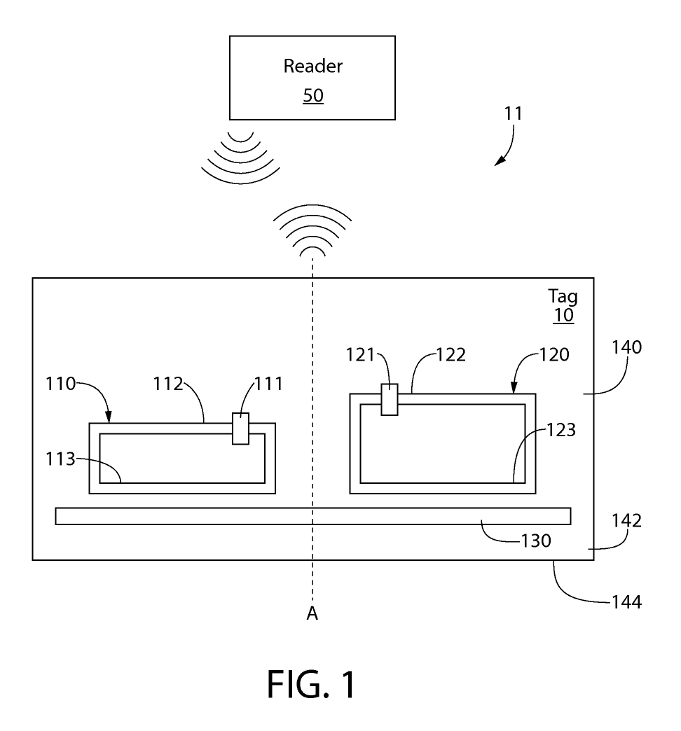

FIG. 1 shows a system 11 according to one embodiment of the present invention. The system includes an RFID reader 50 and a UHF RFID tag 10. The reader 50 can be any device with one or more antennas for emitting radio waves and receiving signals back from the tag 10. Note that the reader 50 and tag 10 of FIG. 1 are not drawn to scale, as a reader is typically larger than a tag. The tag 10 is shown larger to better illustrate its components.

A typical UHF RFID tag has a dipole antenna (for far field communication), an integrated circuit (IC), and a single magnetic loop (for near field communication) that, when combined with the chip input capacitance, will create a single resonant frequency. The tag 10 of FIG. 1 also includes a dipole antenna 130. But in contrast to the typical UHF RFID tag, the tag 10 has two loop antennas 110, 120 and two ICs 111, 121. The one dipole antenna 130 can be operatively coupled to the two loop antennas 110, 120 and, in turn, the two ICs 111, 121 to create an ability for the tag to operate at two different resonant frequencies. Specifically, the dipole antenna 130 can receive RF energy from the reader 50, and the dipole antenna 130 can excite the loop antennas 110, 120 with the RF energy. The ICs 111, 121 can be excited through the loop antennas 110, 120 by inductive coupling. Thus, when operatively coupled to the dipole antenna 130, a first loop antenna 110 and first integrated circuit 111 can have a first resonant frequency, and a second loop antenna 120 and second integrated circuit 121 can have a second resonant frequency. It can alternatively be said that a loop antenna alone has a resonant frequency.

The two RFID integrated circuits (ICs) 111, 121 may be operably coupled, respectively, to the two loop antennas 110, 120. Being operatively coupled requires that the coupled components operate together to perform a given operation, but does not require a physical connection or even a direct electrical connection (e.g., via a wire or electrical trace). In the exemplified embodiment, each IC 111, 121 is a microelectronic semiconductor device for carrying out the functions of the tag 10. The operable coupling of each IC 111, 121 to one of the loop antennas 110, 120 can be accomplished by, for example, electrically coupling contacts of the IC 111, 121 to connection pads of the loop antennas 110, 120. Such coupling can utilize conductive flanges that connect to the IC contacts to form a chip strap that bridges a gap in the loop antenna 110, 120. In alternative embodiments, the operable coupling of the ICs 111, 121 to the loop antennas 110, 120 can be accomplished by any means sufficient to enable each IC and loop antenna pair to communicate data.

The IC 111, 121 can be any properly programmed circuit device, such as a microprocessor or computer, configured for executing the necessary instructions (e.g. code). The IC 111, 121 may be embodied in hardware of any suitable type and may include typical ancillary components necessary to form a functional data processing device, including without limitation data storage, input/output devices, and communication interface devices. The IC 111, 121 can be configured with specific algorithms for carrying out its functions.

The tag 10 includes a substrate 140 having a first surface 142 and a second surface 144 (opposite to first surface 142). In the exemplified embodiment, the antennas 110, 120, 130 and the ICs 111, 121 are located on the first surface 142 of the substrate. In other embodiments, each of these components 110, 120, 130, 111, 121 can be located on either side of a substrate.

In the exemplified embodiment, the tag 10 receives a reader signal from the reader 50, and then transmits or reflects or backscatters two response signals to the reader 50 using passive RFID technology. Specifically, the response signals are generated using modulated backscatter technology whereby the tag 10 converts the energy received from the reader signal into electricity that can power the ICs 111, 121. Providing power to ICs 111, 121 enables the tag 10 to send data stored on the ICs (such as an EPC code) to the reader 50.

The invention is not limited to passive RFID or modulated backscatter technology. Other RFID technologies can be used, such as semi-passive and active RFID (e.g., battery-assisted RFID elements). Further, the invention is not limited to RFID technology, as it can apply to other technologies using loop and dipole antennas. The dipole antenna 130 can be any antenna with two conductive sides and configured for communication with a reader 50, including a straight line dipole. The loop antennas 110, 120 can be any antennas comprising a conductive loop that are configured for communication with a reader. The reader 50 (sometimes referred to as an interrogator) can be any device for sending signals to or receiving signals from a tag. The tag 10 can be any device or label that can be attached directly or indirectly to an object and uses a dipole antenna and at least two loop antennas for communicating with a reader.

The loop antennas 110, 120 and dipole antenna 130 may be physically isolated from each other while still being operatively coupled. “Physically isolated,” as understood herein, means that there is no physical contact between the elements. Thus, if the first loop antenna 110, second loop antenna 120, and dipole antenna 130 are physically isolated from one another, there is no physical contact between the first loop antenna 110, the second loop antenna 120, and the dipole antenna 130. This can be accomplished, for example, by separating the antennas 110, 120, 130 on one side of the substrate, or by placing one or more antennas on an opposite side of the substrate. Physically isolated does not require that the electromagnetic properties of the loop antennas and dipole antenna have no effect upon each other. For example, although the loop antennas 110, 120 and the dipole antenna 130 of FIG. 1 are physically isolated from each other, there may be inductive coupling between the components. Alternatively, according to some example embodiments, the loop antennas 110, 120 and the dipole antenna 130 may be physically and electrically connected (e.g., via a trace).

The location, size, and shape of the antennas can vary. In FIG. 1, two, small, rectangular-shaped loop antennas 110 are located side-by-side on one side of a longitudinal axis of the straight line dipole antenna 130. The loop antennas 110, 120 each have an outer perimeter 112, 122 and an inner perimeter 113, 123, the outer perimeters 112, 122 being different and the inner perimeters 113, 123 being different. A reference line “A” is perpendicular to the longitudinal axis of the dipole antenna 130 and intersects a midpoint of the dipole antenna 130. The loop antennas 110, 120 are located an equal distance from line A on opposing sides of line A. In other embodiments, the antennas 110, 120, 130 can be placed at any location on the substrate 140 sufficient for the antennas 110, 120, 130 to communicate with the reader 50 as discussed herein.

The loop antennas 110, 120 of FIG. 1 are a different size to cause different inductances and thereby different resonant frequencies. According to some example embodiments, the inner perimeters 113, 123 may determine the inductive contribution of the loop antennas 110, 120 and, in turn, the respective resonant frequency. Loop 110 has a smaller inner perimeter than loop 120, and therefore has a higher resonant frequency than loop 220. The size, shape, and location of a loop antenna can be modified to tune the resonant frequency as desired. For example, loop antennas can be square, oval, or circle, and can be placed at various locations on either surface of a substrate.

In the exemplified embodiment of FIG. 1 there are two loop antennas 110, 120. In other embodiments, however, there can be more than two loop antennas. For example, a four-loop tag can be used by one desiring four resonant frequencies. Each loop antenna can have its own IC.

Further, for an RFID tag, each IC can have the same electronic product code (EPC) number, or a different EPC number. If the EPC numbers are different, they can have similar components indicating that they share a common tag.

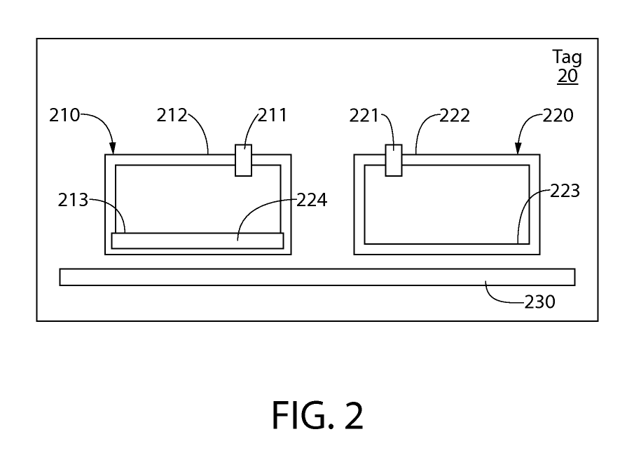

FIG. 2 shows a tag 20 according to another embodiment. The tag 20 differs from tag 10 in that the initial loop antennas 210 and 220 are the same shape and size. A conductive covering 224, however, covers a small portion of the first loop antenna 210 to tune the first loop antenna 210. The covering 224 effectively reduces the size of the first loop antenna 210. In the exemplified embodiment, the covering tunes the resonant frequency of the first loop antenna 210 higher than that of the second loop antenna 220 such that first loop antenna 210 and IC 211 have a resonant frequency of approximately 1100 MHz, while the second loop antenna 220 and IC 221 have a resonant frequency of approximately 950 MHz.

Similar to FIG. 1, the loop antennas 210, 220 of FIG. 2 each have an outer perimeter 212, 222 and an inner perimeter 213, 223. In the embodiment shown in FIG. 1, the outer perimeters 112, 122 of the respective loop antennas are different, and the inner perimeters of the respective loop antennas are different. By contrast, in FIG. 2, the outer perimeters 212, 222 are the same. Further, the inner perimeters 213, 223 would be the same but for the conductive covering 224, which causes the inner perimeters 213, 223 to be different. As discussed above, this change in perimeter alters the inductance and resonant frequency of the first loop antenna 210 and first IC 211.

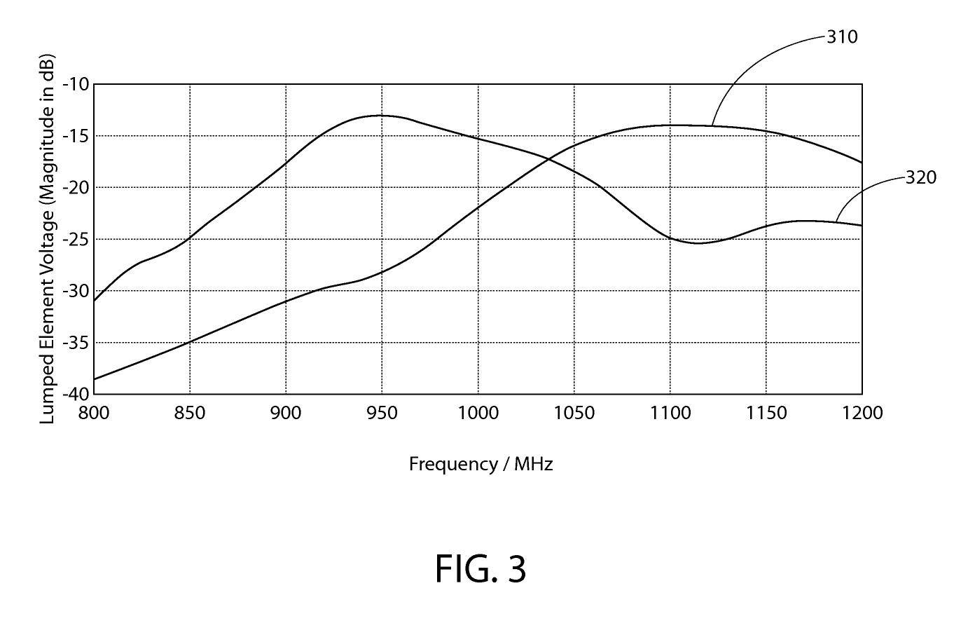

FIG. 3 shows a graph of a simulated frequency response for the tag 20 of FIG. 2. Line 310 is the response of loop antenna 210, and line 320 is the response of loop 220. As can be seen, the decreased size of the first loop antenna 210 causes a smaller inductance, which leads to a higher resonant frequency. It can be seen that line 310 peaks at approximately 1100 MHz (the first resonant frequency), while line 320 (which represents the uncovered loop antenna 220) peaks at approximately 950 MHz (the second resonant frequency). This simulated response shows that the same dipole 230 can operatively couple with two loops 210, 220 with two distinct resonant frequencies.

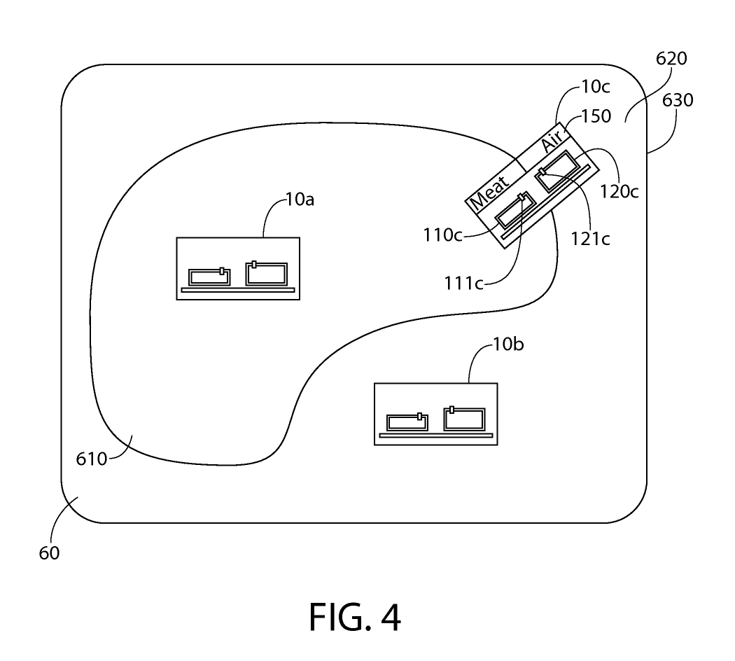

FIG. 4 shows a tagged meat package 60 according to one embodiment of the present invention. The package 60 includes a holder 630 of a suitable material (e.g., closed-cell polystyrene foam), and a meat product 610. The meat package 60 can be overlaid with a clear plastic (not shown), such as, for example, a vinylidene chloride polymer based wrap to keep the meat product 610 in the holder 630 and provide a barrier between the meat product 610 and the environment. This results in an air gap 620 in certain portions of the meat package 60 where there is no meat product 610 beneath the clear plastic.

In FIG. 4, three tags 10a, 10b, 10c are on the package. Tags 10a and 10b are the same in design, but placed in different locations. Tag 10a is placed over the meat, where there is no air gap or space between the meat and the label (absent the clear plastic covering). By contrast, tag 10b is placed over the air gap. Similar to the tags 10, 20 of FIGS. 1 and 2, tags 10a and 10b have two loops of differing size that cause two resonant frequencies. For each tag 10a, 10b, the first resonant frequency is tuned for application to meat (or a material with a similar fluid profile) with no air gap (e.g., the frequency shifted down 200 MHz) and the second resonant frequency is tuned for application in the presence of an air gap (e.g., the frequency shifted down 50 MHz). As a result, whether the tags are placed over the meat (as in tag 10a) or the air gap (as in tag 10b), one of the ICs will be shifted to a desired 900 MHz range and therefore be effective to receive and transmit signals. In other words, if the tag is placed over the meat, the first loop and IC will be suited for communication with the reader (while the second loop may be detuned), and if the tag is placed over the air gap, the second loop and IC will be suited for communication with the reader (while the first loop may be detuned). Because the tag is configured to work either on the meat 610, or on the air gap 620, the applier of the tag need not be concerned about which section the tag 10a, 10b is placed upon.

Tags 10a and 10b concern circumstances where one loop is tuned, while the other loop is detuned. For maximum performance of the tag, however, it may be ideal to have both loops tuned and working. This can be accomplished by having the first loop antenna 110c and IC 111c (tuned for meat) positioned over the meat 610, and the second loop antenna 120c and IC 121c (tuned for an air gap) positioned over the air gap 620, as is done with tag 10c.

Tag 10c can be designed similar to tags 10a and 10b. But to facilitate the proper application of tag 10c between the meat 610 and the air gap 620, tag 10c also includes indicia 150. The indicia 150 indicate, to the applier of the tag 10c, the ideal position for placing the tag 10c. In FIG. 4, the indicia instruct the applier to place the first loop 110c over the meat 610, and the second loop 120c over the air gap 620. Permitting both loops to be functional may provide numerous advantages, such as (1) providing a backup loop that is functional in the event one of the loops fails; and (2) providing an enhanced read performance by expanding the number of magnetic loops. Also, if the applier does not follow the instructions provided on the indicia, the multiple loops will still permit the RFID tag 10c to function by using the magnetic loop placed on the surface for which it was tuned (as described above with regard to tags 10a and 10b). The invention is not limited to tags placed on meat products. The invention can be relevant to any object that may cause tag detuning.

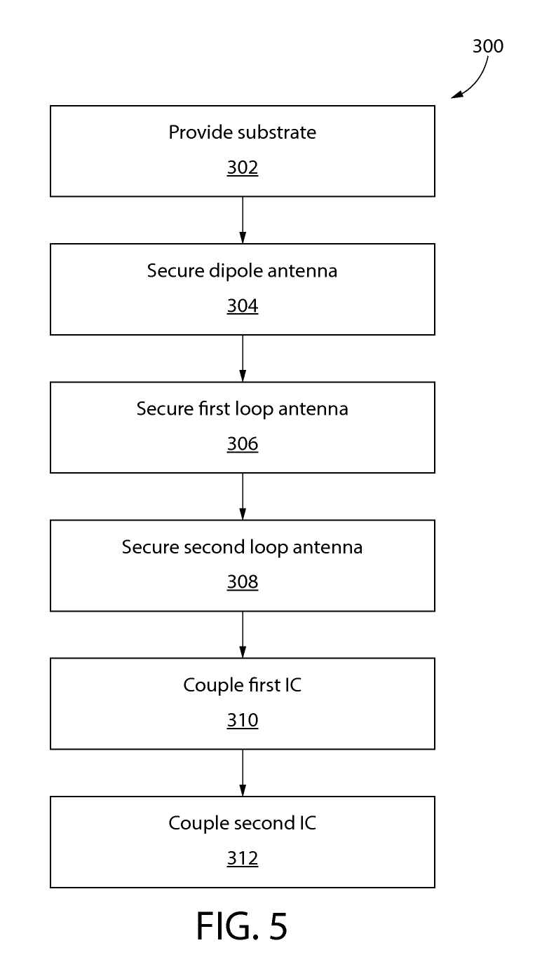

FIG. 5 is a flowchart of a method 300 of manufacturing an RFID tag according to one embodiment of the present invention. First, a substrate is provided (operation 302). The method 300 can then secure the dipole antenna (operation 304), the first loop antenna (operation 306), and the second loop antenna (operation 308) to the substrate. The method 300 can then operatively couple an IC to each of the first loop antenna (operation 310) and the second loop antenna (operation 312). As previously indicated, the antennas can be to either side of the substrate, and at a variety of locations on the respective sides. Further, the antennas can be secured in any order. Further, the ICs can be coupled as discussed above, and in any order.

While the invention been described with respect to specific examples, those skilled in the art will appreciate that there are numerous variations and permutations of the above described invention. It is to be understood that other embodiments may be utilized and structural and functional modifications may be made without departing from the scope of the present invention. Thus, the spirit and scope should be construed broadly as set forth in the appended claims.

What is claimed is:

1. A radio frequency identification (RFID) tag comprising:
a substrate;
a dipole antenna on the substrate;
a first loop antenna on the substrate;
a first integrated circuit operably coupled to the first loop antenna;
a second loop antenna on the substrate; and
a second integrated circuit operably coupled to the second loop antenna;
wherein the first loop antenna is operatively coupled to the dipole antenna and the first integrated circuit to operate at a first resonant frequency, and the second loop antenna is operatively coupled to the dipole antenna and the second integrated circuit to operate at a second resonant frequency, the first resonant frequency being different from the second resonant frequency.

2. The RFID tag of claim 1 wherein the first loop antenna has a first inner perimeter and the second loop antenna has a second inner perimeter, the first inner perimeter being different from the second inner perimeter.

3. The RFID tag of claim 2 wherein the first loop antenna has a first outer perimeter and the second loop antenna has a second outer perimeter, the first outer perimeter being substantially equal to the second outer perimeter.

4. The RFID tag of claim 1 wherein:
the substrate comprises a first surface and a second surface opposite the first surface; and
the dipole antenna, the first loop antenna, and the second loop antenna are on the first surface of the substrate.

5. The RFID tag of claim 1 wherein the dipole antenna is a straight line dipole.

6. The RFID tag of claim 1 wherein the dipole antenna has a longitudinal axis, and the first loop antenna and the second loop antenna are located on a first side of the longitudinal axis.

7. The RFID tag of claim 1 wherein the dipole antenna, the first loop antenna, and the second loop antenna are located on the substrate so as to be physically isolated from one another.

8. The RFID tag of claim 1 wherein:
the dipole antenna has a longitudinal axis;
a reference axis is perpendicular to the longitudinal axis and intersects a center point of the dipole antenna;
the first loop antenna is located on a first side of the reference axis; and
the second loop antenna is located on a second side of the reference axis.

9. The RFID tag of claim 1 wherein the loops are rectangular.

10. The RFID tag of claim 1 wherein the first loop antenna further comprises a conductive covering, the conductive covering causing the first resonant frequency to be different from the second resonant frequency.

11. The RFID tag of claim 1 wherein the first loop antenna is configured to prevent detuning caused by a meat product, and the second loop antenna is not configured to prevent detuning caused by a meat product.

12. The RFID tag of claim 1 wherein the first integrated circuit has a first EPC code and the second integrated circuit has a second EPC code.

13. A method comprising:
providing a substrate;
securing a dipole antenna to the substrate;
securing a first loop antenna to the substrate;
operably coupling a first integrated circuit to the first loop antenna;
securing a second loop antenna to the substrate; and
operably coupling a second integrated circuit to the second loop antenna;
wherein the first loop antenna is operatively coupled to the dipole antenna and the first integrated circuit to operate at a first resonant frequency, and the second loop antenna is operatively coupled to the dipole antenna and the second integrated circuit to operate at a second resonant frequency, the first resonant frequency being different from the second resonant frequency.

14. The method of claim 13 wherein the first loop antenna has a first inner perimeter and the second loop antenna has a second inner perimeter, the first inner perimeter being different from the second inner perimeter.

15. The method of claim 14 wherein the first loop antenna has a first outer perimeter and the second loop antenna has a second outer perimeter, the first outer perimeter being substantially equal to the second outer perimeter.

16. The method of claim 13 further comprising attaching a conductive covering to the first loop antenna, the conductive covering causing the first resonant frequency to be different from the second resonant frequency.

17. The method of claim 13 wherein the first integrated circuit has a first EPC code and the second integrated circuit has a second EPC code.

18. A tag comprising:
a substrate;
a dipole antenna on the substrate;
a first loop antenna on the substrate; and
a second loop antenna on the substrate;
wherein the first loop antenna is operatively coupled to the dipole antenna and the first integrated circuit to operate at a first resonant frequency, and the second loop antenna is operatively coupled to the dipole antenna and the second integrated circuit to operate at a second resonant frequency, the first resonant frequency being different from the second resonant frequency.

19. The tag of claim 18 wherein the first loop antenna has a first inner perimeter and the second loop antenna has a second inner perimeter, the first inner perimeter being different from the second inner perimeter.

20. The tag of claim 19 wherein the first loop antenna has a first outer perimeter and the second loop antenna has a second outer perimeter, the first outer perimeter being substantially equal to the second outer perimeter.
